(19) United States
(12) Patent Application Publication
(10) Pub. No.: US 2012/0052944 A1
(43) Pub. Date: Mar. 1, 2012

(54) TIME REACTION GAME WITH VIBRATION SENSORS

(75) Inventors: Damon R. Saddler, Inglewood, CA (US); Stephen Lau, Torrance, CA (US); Jeff W. Bazarko, Hawthorne, CA (US); Stephen C. Hallaian, Long Beach, CA (US)

(73) Assignee: MATTEL, INC., El Segundo, CA (US)

(21) Appl. No.: 13/219,407

(22) Filed: Aug. 26, 2011

Related U.S. Application Data
(60) Provisional application No. 61/377,389, filed on Aug. 26, 2010.

(51) Int. Cl. A63F 13/00

(52) U.S. Cl. 463/31

(57) ABSTRACT

A timed reaction game apparatus is provided. The apparatus may include an electronic console and a plurality of illumination areas disposed on the electronic console. The plurality of illumination areas may include an array having a radial symmetry and may be configured to display a visual cue sequence. The apparatus may further include an array of vibration sensors attached to the electronic console in substantial radial alignment with the illumination areas, wherein each of the vibration sensors is associated with a target zone and is configured to locate a tapping response proximate to a respective vibration sensor, and a processor configured to generate a visual cue sequence, to record a tapping response sequence detected by the vibration sensors, and to generate a score based on temporal correlation and spatial correlation between a visual cue sequence and a tapping response sequence.

### CROSS-REFERENCE TO RELATED APPLICATIONS

This application claims priority under 35 U.S.C. §119 to U.S. Provisional Patent Application Ser. No. 61/377,389, filed Aug. 26, 2010 and entitled TIME REACTION GAMES WITH VIBRATION PROXIMITY SENSORS, the complete disclosure of which is incorporated herein by reference for all purposes.

### FIELD OF THE DISCLOSURE

The present disclosure is directed to timed reaction games, and more particularly to timed reaction games having a vibration sensor configured to determine the proximate location of a percussive response produced by a player.

### BACKGROUND

Many games may require a player to react with precise timing to a presented cue or series of cues. Some games further require a player to control both the timing and location of a response to a presented cue or cue series. For example, the early electronic game Pong presents a player with a visual cue series, depicted as a progressive event track for a virtual ball moving across a screen, and requires the player to respond by moving a virtual paddle to intercept the event track where and when it reaches an horizon. Examples of electronic games, toys and devices including proximity sensors are shown in U.S. Pat. Nos. 4,974,850, 5,737,431, and 7,215,785, and U.S. Patent Application Nos. US20080004111 and US20080039199. The complete disclosures of these and all other publications referenced herein are incorporated by reference for all purposes.

### SUMMARY

A timed reaction game apparatus is provided. The apparatus may include an electronic console and a plurality of illumination areas disposed on the electronic console. The plurality of illumination areas may include an array having a radial symmetry and may be configured to display a visual cue sequence. The apparatus may further include an array of vibration sensors attached to the electronic console in substantial radial alignment with the illumination areas, wherein each of the vibration sensors is associated with a target zone and is configured to locate a tapping response proximate to a respective vibration sensor, and a processor configured to generate a visual cue sequence, to record a tapping response sequence detected by the vibration sensors, and to generate a score based on temporal correlation and spatial correlation between a visual cue sequence and a tapping response sequence.

A further example of a timed reaction game apparatus is provided. The apparatus may include an electronic console including a plurality of arms radially extending from the electronic console, each arm associated with a target zone, and a plurality of illumination areas disposed on the electronic console including an array of illumination areas in approximate alignment with the plurality of arms and configured to display a visual cue sequence. The apparatus may further include an array of vibration sensors attached to the electronic console in approximate alignment with the plurality of arms, the vibration sensors configured to detect a tapping response sequence in the target zones and a processor configured to generate a visual cue sequence displayed by the illumination areas, to record a tapping response sequence detected by the vibration sensors, and to generate a score based on temporal and spatial correlation between the visual cue sequence and the tapping response sequence. Some embodiments may further include a play surface in operable contact with the array of vibration sensors and configured to provide a substantially isolated vibration translation environment in a predefined area around each vibration sensor such that transmission of vibration into neighboring target zones is reduced.

A further embodiment of a timed reaction game apparatus is provided, the apparatus may include an electronic console, a plurality of illumination areas disposed on the electronic console, the plurality of illumination areas including an array of illumination areas configured to display a visual cue sequence, an array of vibration sensors attached to the electronic console in approximate alignment with the array of illumination areas, each vibration sensor associated with a target zone and configured to locate a tapping response in the target zone and/or a play surface in operable contact with the array of vibration sensors and configured to provide a substantially isolated vibration translation environment in a predefined area around each vibration sensor such that transmission of vibration into neighboring target zones is reduced.

A method of a timed reaction game processing is also provided, the method including generating a visual cue sequence for display by an array of illumination areas disposed on an electronic console, the array of illumination areas having a radial symmetry, recording a tapping response sequence detected by an array of vibration sensors attached to the electronic console, the array of vibration sensors in substantial radial alignment with the array of illumination areas, and/or generating a score based on temporal and spatial correlation between the visual cue sequence and the tapping response sequence.

Advantages of the present disclosure will be more readily understood after considering the drawings and the Detailed Description.

### BRIEF DESCRIPTION OF DRAWINGS

FIG. 1 is a perspective view of an exemplary embodiment of a timed reaction game device according to the present disclosure including an electronic console with a domed upper portion having a plurality of illuminated surfaces disposed as an array with circular and axial symmetries, which may be used to present visual cue series with variations in both timing and spatial orientation.

FIGS. 2a and 2b are upper views of the electronic console of FIG. 1 showing axial and circular organization of the illuminated surfaces correlated with zones of a subjacent play surface.

FIG. 3 shows a side view of the game device of FIG. 1, showing an upper domed portion mounted to a lower base portion.

FIG. 4 is a lower view of the game device of FIG. 1, showing a base portion of the console further including illumination devices and vibration sensors configured for detecting a proximate location of vibrations of a subjacent play area.

FIG. 5 is a lower perspective view of the game device of FIG. 1, further showing a generally circular array of vibration sensors positioned in correspondence with visual axes.

FIG. 6 shows a plan view of a tiled game board which may be used as a play surface for a game device according to the present disclosure.

FIG. 7 shows a hand-held tapping device that may be used by a player to generate consistent percussive responses during game play according to the present disclosure.

FIG. 8 shows a perspective view of an alternative exemplary embodiment of a timed reaction game device according to the present disclosure including an electronic console having illuminated surfaces disposed as an array with circular and axial symmetries and a play surface.

FIGS. 9a-9e show perspective views of assembly of the play surface of FIG. 8.

FIG. 10 shows an upper perspective view of the electronic console of FIG. 8.

FIG. 11 shows an upper perspective view of the electronic console of FIG. 8.

FIGS. 12a, 12b and 13 show an upper view of the electronic console of FIG. 8 showing axial and circular organization of the illuminated surfaces correlated with zones of a subjacent play surface.

FIG. 14 shows a side view of the console of FIG. 8, showing an upper domed portion mounted to a lower base portion.

FIG. 15 shows an alternative side view of the console of FIG. 8.

FIG. 16 shows an alternative side view of the console of FIG. 8, facing the speaker grill.

FIGS. 17a, 17b and 17c show a lower view of the console of FIG. 8, showing a base portion of the console including vibration sensors configured for detecting a proximate location of vibrations in an adjacent play area and a power switch.

FIG. 18 is a lower perspective view of the console of FIG. 8, further showing a generally circular array of vibration sensors positioned in correspondence with radially extending arms.

FIGS. 19-23 show modes of game play for using a game device of according to the present disclosure.

FIG. 24 shows a flow diagram of an exemplary method of a timed reaction game processing in accordance with the present disclosure.

### DETAILED DESCRIPTION OF THE DISCLOSURE

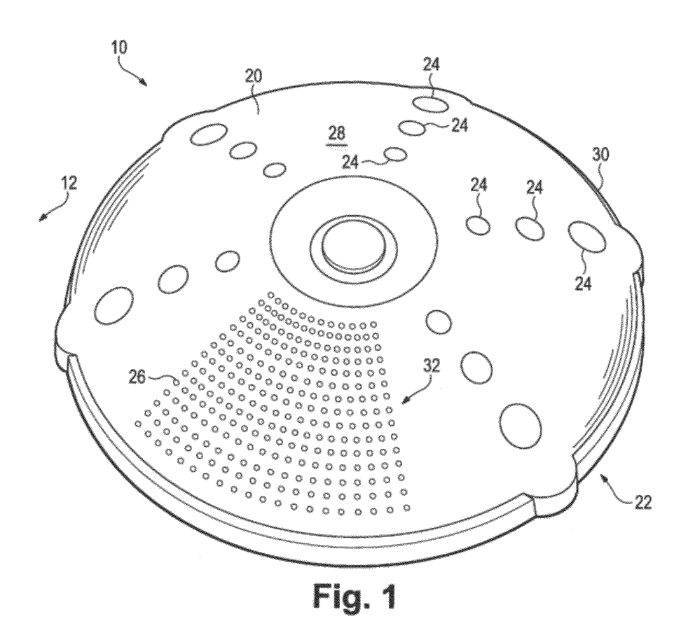

FIG. 1 depicts a nonexclusive illustrative example of an electronic timed reaction game device shown generally at 10, in the form of an electronic console. Preferably, console 10 is configured to rest stably on a play surface 12, for example a solid flat surface. Unless otherwise specified, console 10 may but is not required to contain at least one of the structures, components, functionalities, concepts, and/or variations described, illustrated, and/or incorporated herein.

Console 10 may include a domed upper portion 20 mounted on a lower base portion 22. Domed upper portion 20 may include a plurality of output devices, including for example illumination areas 24 and/or a speaker 26 disposed in an upper surface 28 of upper portion 20. Illumination areas 24 and/or a speaker 26 may be configured to present a combination of visual and auditory cues to a player. Upper portion 20 and lower base portion 22 may have generally circular shapes of similar diameters, such that when joined, console 10 has a generally discoid shape including a generally circular margin 30.

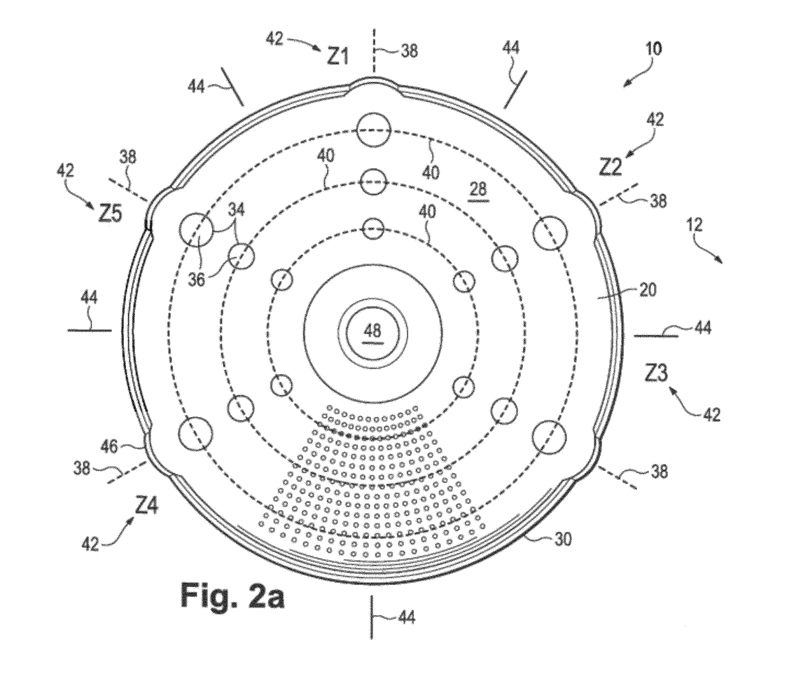

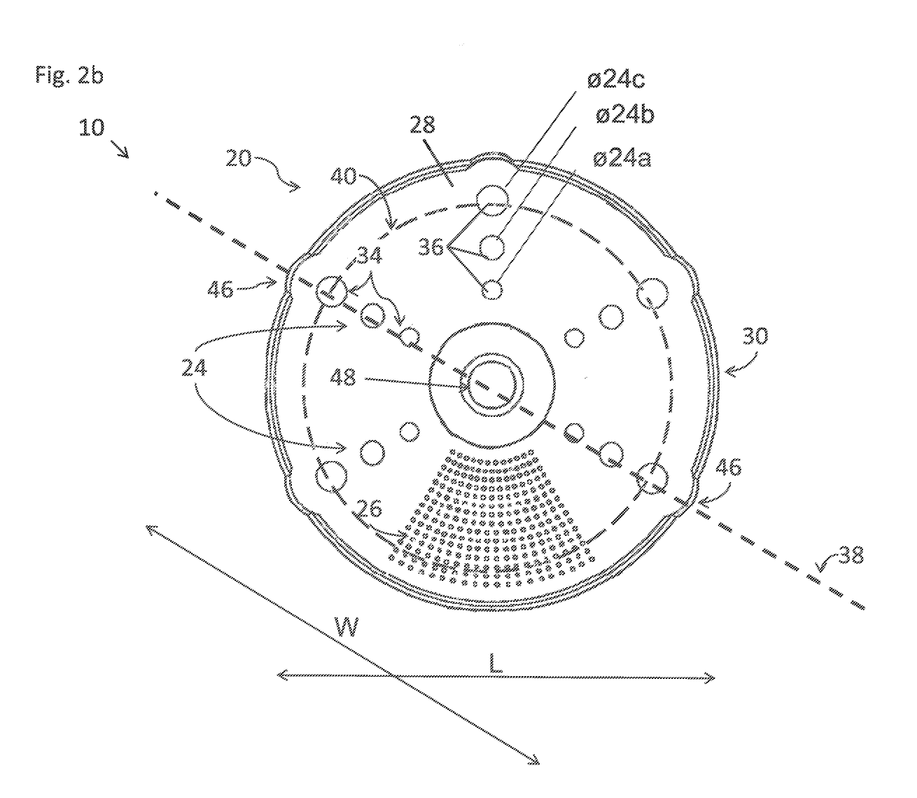

Upper surface 28 may be formed of a resilient formable material, such as polycarbonate plastic, and may particularly include a clear shell body under-painted to provide an attractive visual aspect to console 10. As shown more particularly in FIG. 2a, illumination areas 24 may include substantially transparent portions of upper surface 28, such as circular discs 34 and/or rings, and may include translucent frosted substrates or panes 36 to evenly diffuse emitted light. Upper surface 28 may further include a grill 32 for speaker 26. Not shown are LED lights that preferably illuminate portions of console 10.

As further shown in FIG. 2a, a plurality of illumination areas 24 may be disposed on upper surface 28 to form a visual cue array with a one or both of radial axes 38 and circular arrangements 40. In some embodiments and/or some game play modes, illumination areas 24 may be illuminated in sequences which progress along one or more of the radial axes 38, such as from an innermost illumination area 24 to an outermost illumination area 24 along a radial axis 38. Additionally and/or alternatively, illumination areas 24 may be illuminated in sequences that progress along one or more circular alignments 40, such as in a clockwise direction or a counter-clockwise direction.

As discussed in further detail below with reference to FIGS. 19-23, during game play, illumination areas 24 may be configured to display a visual cue sequence to a player. The visual cue sequence may include a spatial (directional, or orientation) component that is encoded by a direction of progression along at least a first axis, which may include one or more of a radial axis 38, or one or more of a circular arrangement 40. The visual cue sequence may additionally and/or alternatively include a temporal component encoded by the time interval (gap) between illuminations of successive illumination areas 24 in progression along at least the first axis, which it may be appreciated involves progressive illumination of areas 24 along the axes orthogonal to at least the first axis.

For example, the visual cue sequence may appear to radiate along a single spoke, from the center of the domed console to an outer edge, by progressive lighting of illumination areas 24 along one of radial axes 38, such as beginning with an area 24 on an inner circular arrangement 40 and proceeding to areas 24 on the next outer circular arrangements and repeating successively at regular time intervals until a final area 24 on the peripheral circular arrangement 40 is illuminated. In such example, spatial information is encoded by progress along the illuminated radial axis 38, and temporal information is encoded by progress of the illumination series from inner circular arrangement 40 to outer circular arrangement 40.

A large number of visual cue sequence variants may be generated from such an array of illumination surfaces. In some examples, temporal information may be encoded by progression of an illumination sequence along one or more circular arrangements 40 while spatial information is encoded by simultaneous progression along one or more radial axes. In some examples, temporal information may be encoded along a radial axis 38 while spatial information, such as a direction of rotation, is encoded along a circular arrangement 40. Methods of game play incorporating various visual cue series are presented in more detail below.

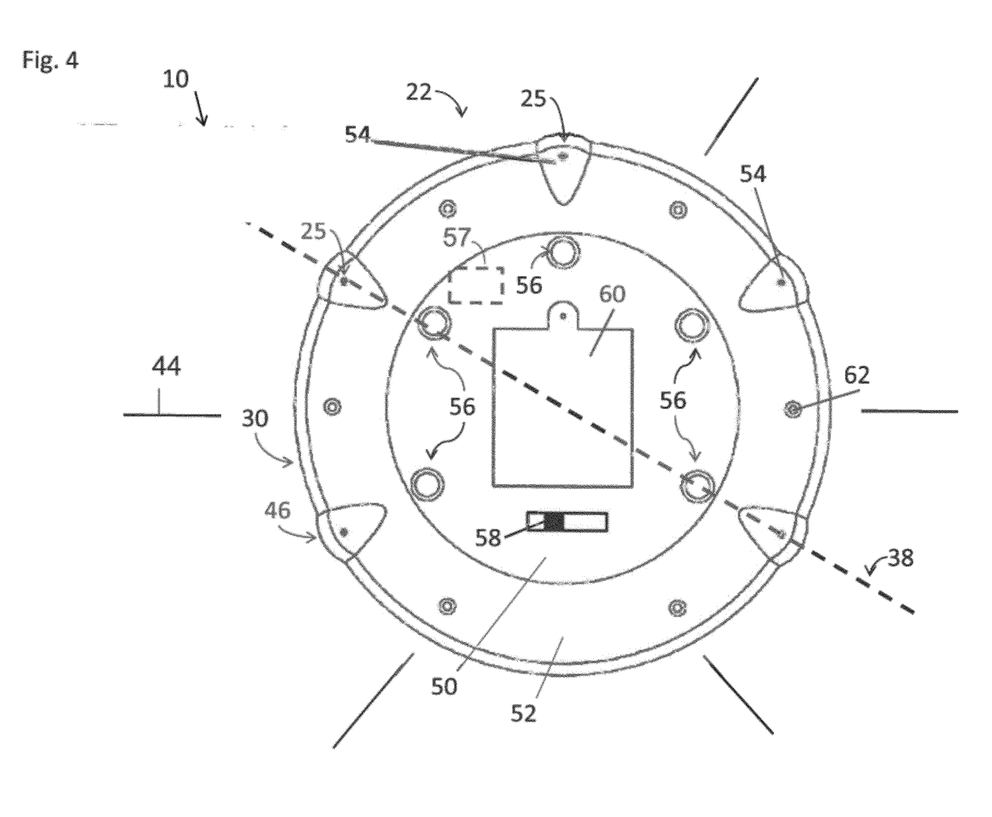

The example shown in 2a further shows extension of radial axes 38 of console upper portion 20 onto the play surface 12 may define play surface zones 42, such as zones Z1 to Z5 depicted. Play surface zones 42 may be separated by zone boundaries 44, which may occur approximately equidistant from adjacent radial axes 38, and/or at a mid-point between each successive radial axes 38 of illumination areas 24. Additionally and/or alternatively, as shown in FIG. 4, zone boundaries 44 may occur approximately at a mid-point between successive vibration sensors 56. In some embodiments, zones 42 may be uniformly sized and in alternative embodiments zones 42 may be non-uniformly sized.

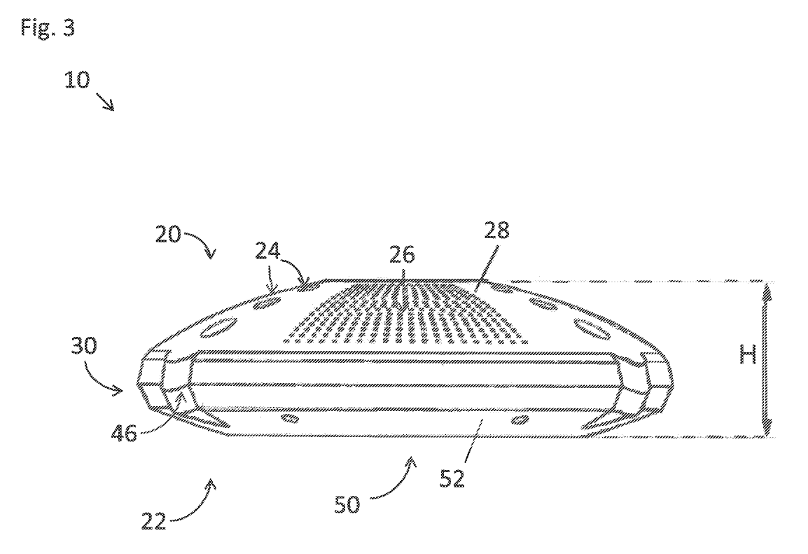

Console 10 may include additional features that guide player in easily identifying play surface zones in relation to console 10. In some examples, margin 30 may include lateral extensions 46, also referred to as arms, which may include lateral extensions of domed upper portion 20 and/or lower base 22, as shown in FIG. 3. In some examples, the extensions of the plurality of radial axes 38 on play surface 12 may be illuminated by a plurality of bottom illumination surfaces 25 that are disposed on lower base 22, and which are particularly aligned with the directional orientation of radial axes 38 on upper portion 20. In some embodiments, bottom illumination surface 25 on lower base 22 may coincide with lateral extensions 46 of margin 30.

Console 10 may include user input devices, such as buttons or switches, which may allow a player to control aspects and/or features of game play, and/or interact with game mode and feature menus. For example, domed upper portion 20 may include a central control button 48, as shown in FIGS. 2a and 2b.

FIG. 2b shows upper portion 20 including a plurality of illumination areas 24, such as lighted rings 34 having translucent panes 36, which together are configured as a visual cue array based on a combination of radial axes 38 and circular arrangements 40 (examples of such axes indicated by dotted lines). FIG. 2b further shows in simplified form that illumination areas 24 occupy or define positions (nodes) where radial axes 38 intersect circular arrangements 40. During game play, illumination of an area 24 may thereby mark both a temporal step in a visual cue sequence and a direction (spatial) step in the visual cue sequence.

In addition, FIG. 2b further shows that margin 30 of console 10 may include lateral extensions 46 substantially aligned with radial axes 38. Extensions 46 may thereby provide players with a visual indicator for extension of axes 38 onto the play surface 12, and may further indicate a central region of play surface zones 42 (as shown in FIG. 2a). In some embodiments, console 10 may be configured to have a generally circular margin 30, which may facilitate a regular disposition of illumination areas 24, radial axes 38, and circular arrangements 40. However, other embodiments of console 10 are contemplated and further described below. Some embodiments may include a non-circular margin 30, such as an oval margin 30 or a geometric (e.g., polygonal) margin 30, which may or may not include lateral extensions 46 to aid in identifying play surface zones 42.

FIG. 2b further provides an exemplary configuration of relative dimensions for a console 10, including relative dimensions at margins 30, lateral extensions 46, a central area surrounding central button 48, and illumination areas 24 including translucent panes 36, which may vary in size for each concentric ring of circular arrangements 40. For example, illumination areas 24 may include five radially extending axes and three illumination areas 24 per radial axis. An innermost illumination area 24a may include a curvature of Ø0.3000, a middle illumination area 24b may include a curvature of Ø0.3750 and an outermost illumination area 24c may include a curvature of Ø0.5000. Console 10 may include a width of 7.9108 inches and a length of 7.6822 inches.

As shown in FIG. 3, domed upper portion 20 may be mounted to lower base 22, forming margin 30 and extensions 46. Preferably, base 22 may include a substantially flat bottom area 50 configured to provide stable support for console 10 on a flat solid play surface, such as a table. More particularly, a flat bottom area 50 that provides a substantially even interaction with a flat play surface may provide an even signal base for a plurality of vibration sensors, described below. In some embodiments, height H of console may include 2.2169 inches.

In some examples, and as further shown in FIG. 3, base 22 may further include an inclined aspect area 52 adjacent margin 30, which may facilitate the illumination of zones of the play surface 12 corresponding to extensions of axes 38 (as shown in FIG. 2), by providing for outwardly-directed lower illumination areas 24 located around the periphery of base 22. To facilitate a generally domed appearance for console 10, lower base 22 may have a reduced vertical profile relative to upper portion 20, providing an overall flattened disc shape with a relative height substantially less than a marginal width (compare relative dimensions indicated in FIGS. 3 and 4).

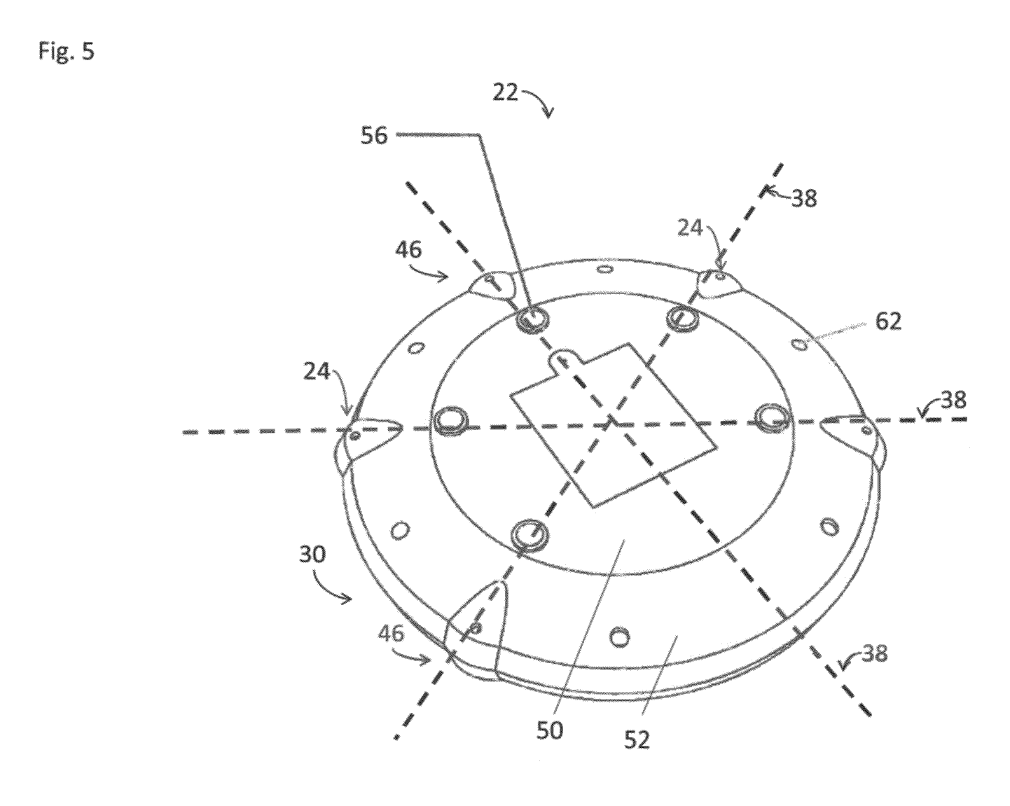

FIG. 4 shows a non-exclusive exemplary configuration of a lower base portion of a game device console 10 that may include a plurality of bottom illumination areas 25. In some examples, bottom illumination areas 25 and or illumination areas 24 may include LEDs 54. As shown in FIG. 4 and further shown in FIG. 5, bottom illumination areas 25 may be disposed adjacent margin 30, and more particularly may be disposed in alignment with radial axes 38, as defined by the disposition of the plurality of illumination areas 24 disposed on an upper surface 20 of console 10 (shown in FIGS. 2a and 2b).

In some examples, as shown in FIGS. 4 and 5, bottom illumination areas 25 may be disposed subjacent lateral extensions 46 of margin 30. Bottom illumination areas 25 and extensions 46 may thereby both serve to orient a player's attention to the portions of the surrounding play surface that are proximate (nearest in distance) each of the plurality of vibration sensors.

Console 10 may include a plurality of vibration sensors 56. Vibration sensors 56 may include piezoelectric microphones capable of converting an externally applied vibration into an electrical input signal for storage and/or processing by an electronic processing unit 57 housed within console 10. Processing unit may compare the time at which a particular vibration is sensed at each of vibration sensors 56, and choose the zone in which a vibration sensor 56 first sensed the particular vibration.

In some embodiments, the vibration sensors 56 may be configured to distinguish among a range of surface vibration intensities by generating electrical signals of different characteristics (such as frequency and/or amplitude) that correlate with surface vibration intensity, such performance capacity permitting a vibration generated at one proximate site adjacent console 10, such as in one play surface zone 42, to be at least directionally distinguished and thereby functionally linked to the proximate (closest) vibration sensor among the plurality of such sensors disposed on lower base 22.

In other embodiments, the vibration sensors 56 sense vibrations within a particular frequency range. Vibrations within a particular frequency range that reach a particular threshold amplitude trigger a signal to the processing unit 57. The processing unit 57 may determine time differentials between signals from different vibration sensors 56 and use the time differentials to determine an associated area or direction from which the vibrations originated.

In yet other embodiments, each of the vibration sensors 56 functions like a button. Vibrations within a particular frequency range that reach a particular threshold amplitude trigger a signal to the processing unit 57. The processing unit 57 may act on the signals from the vibration sensors 56 as if it were a time-division multiplexer and process the game play accordingly.

As shown in FIGS. 4 and 5, lower base 22 may further include a general power on/off switch 58, and an access panel 60 to a battery compartment (not shown) or other suitable internally-housed electrical power supply. Mounting devices 62, such as screws for mounting a domed upper portion 20 to lower base 22, may also be accessible on lower base 22.

Console 10 may further include illumination devices, such as LEDs, and light-reflective chambers or light-directive optical fibers to light illumination areas 24. Console 10 may also include additional electronic devices, such as an electronic signal processor, an electronic controller, electronic signal data recorder, and wiring, which may connect electronic devices, speakers, piezoelectric devices, illumination devices and the like to a battery or other source of electrical energy.

During typical game play using game device console 10, a player may first use central button 48 to choose a game play mode, as by navigating a menu with audio instructions and/or options provided through speaker 26, and further initiate a game, and/or repeated trials within a game, using button 48 and/or by tapping in one or more of the play zones.

Console 10 may display a visual cue sequence including a combination of temporal information (cadence) and spatial information (direction and orientation), by selectively illuminating one or more areas 24 on upper surface 20. In some examples, illumination of areas 24 on lower base 22, such as LEDs 54, may be included in a visual cue sequence. A player may then be required, for credit or advancement in game play, to tap or otherwise percuss the portion play surface 12 adjacent the outermost illumination area and/or radial axis in which illumination occurred, both in cadence with the temporal information of the presented visual sequence (i.e., by first tapping after the time interval used in the visual sequence) and in spatial alignment (direction and orientation) with the presented visual sequence (i.e., by first tapping proximate the sensor position aligned with the orientation of the presented visual sequence, which options may be highlighted by LEDs 54 and/or lateral extensions 46 of margin 30.) However, myriad game variations may be formulated from these basic stimulus/timed-response couplings, some of which are presented in further detail, below.

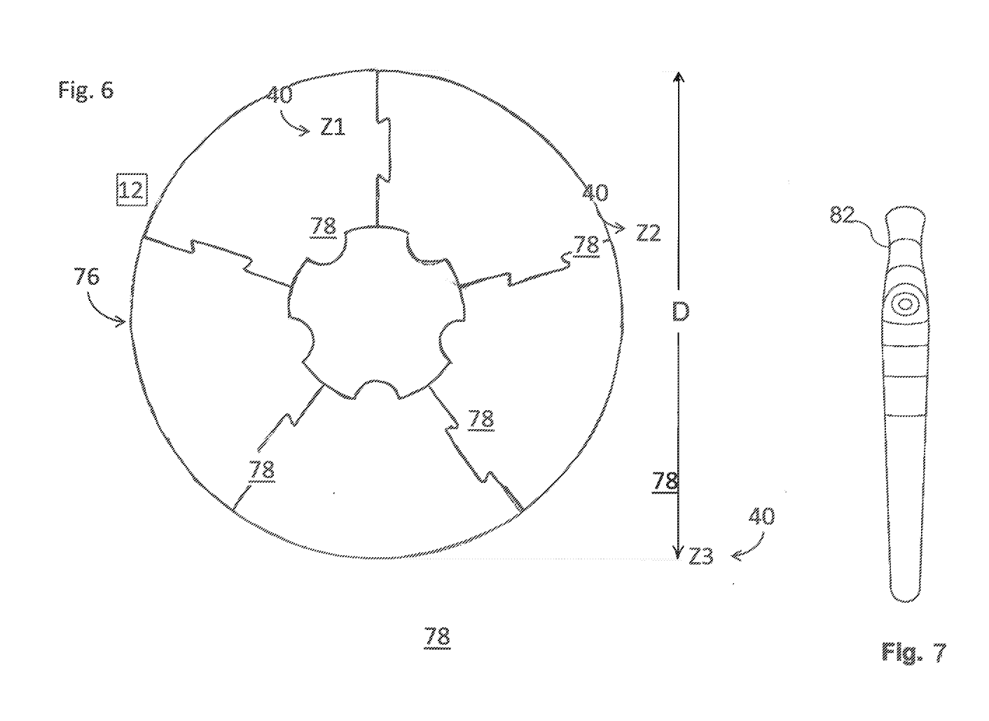

Consistent performance of the game device console 10 may be facilitated by play surface area 12 and/or hand-held tapping devices. FIGS. 1-5 show play surface 12 including a planar unitary play surface. Alternative embodiments of play surface 12 may include non unitary play surfaces. For example, FIG. 6 shows play surface 12 including a board 76 having consistent texture, density, and/or ability to transmit vibration.

Board 76 may include cardboard coated with printed paper, as often found on puzzle pieces. A core of the material may include 900 gram per square meter density “Grey Board” is sandwiched between 128g art paper. Alternatively, the board 76 may be manufactured from molded plastic or another durable material. In some examples, board 76 may be configured to be assembled from tiles, such as tiles 78 as shown in FIG. 6. In some embodiments, tiles 78 may be irregularly shaped. Tiles 78 may be regularly shaped, which may facilitate assembly. More particularly, tiles 78 may be regularly shaped to provide a similar vibration translation environment for each zonal region of the play surface 12 (board 76).

Further, as shown in FIG. 6, board 76 may include a plurality of tiles configured to match the number and angular organization of radial axes 38 and vibration sensors 56, wherein the junctions between tiles 78 may interrupt transmission of vibrations into neighboring play surface zones and thereby increase the fidelity of vibration sensor responses to proximately located taps by a player. Board 76 may include a diameter D of approximately 14.00 inches.

As shown in FIG. 7, some embodiments of the game may include one or more of a hand-held tapping device 82. Player's may employ one or more of tapping device 82 to achieve a more consistent vibration response from vibration sensor 56 and/or on play board 76. Game device 82 may include a substantially elongated tubular shape however alternative embodiments may include a variety of shaped, textured, and colored tapping devices 82 that may provide visual and/or tactile excitement during game play, and/or a personal identification token in game play among several players.

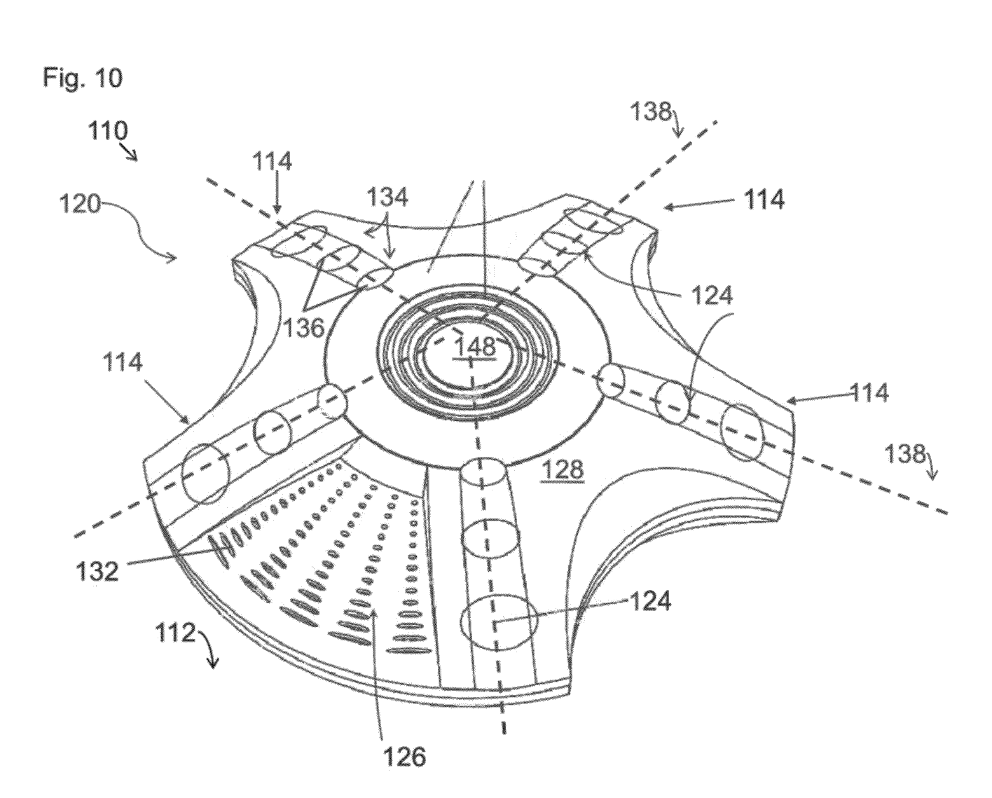

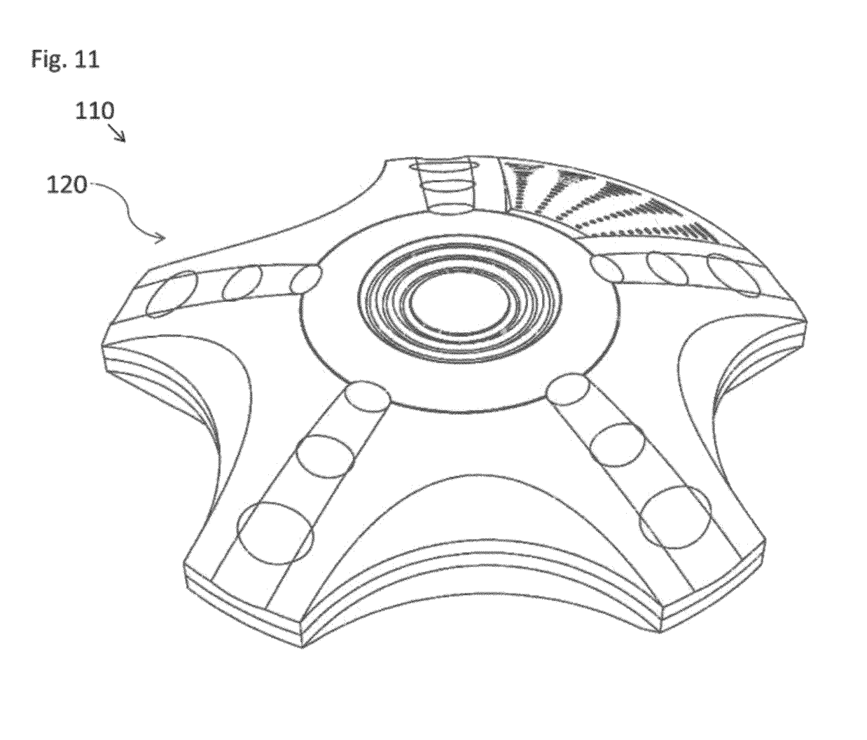

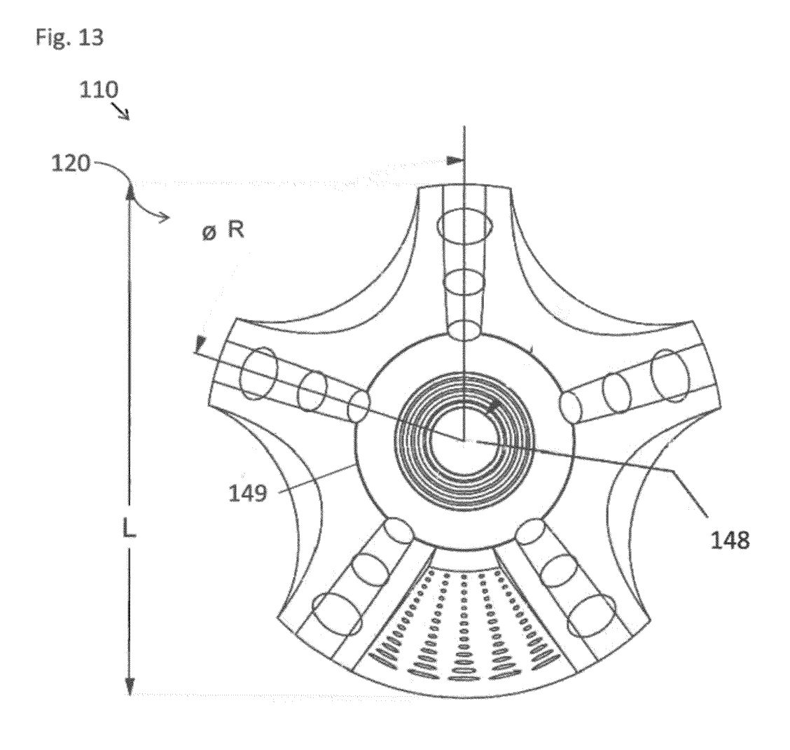

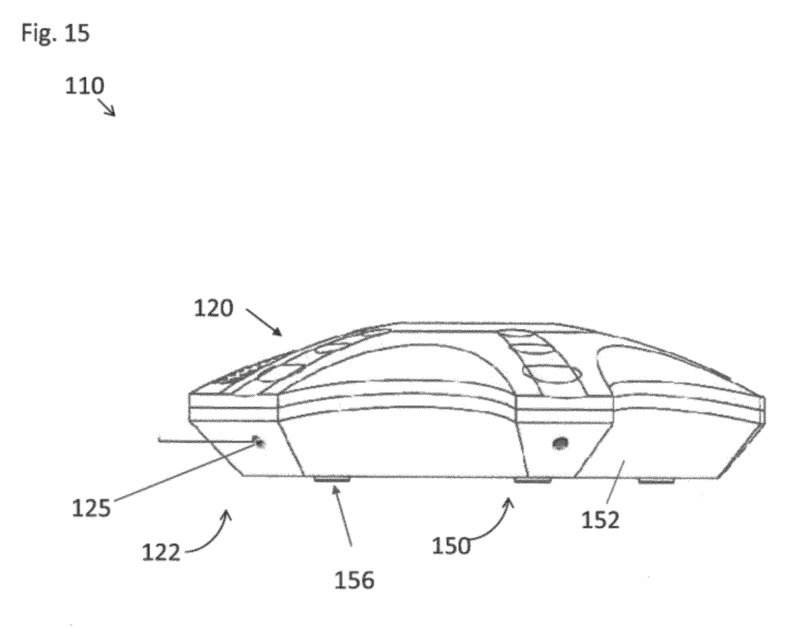

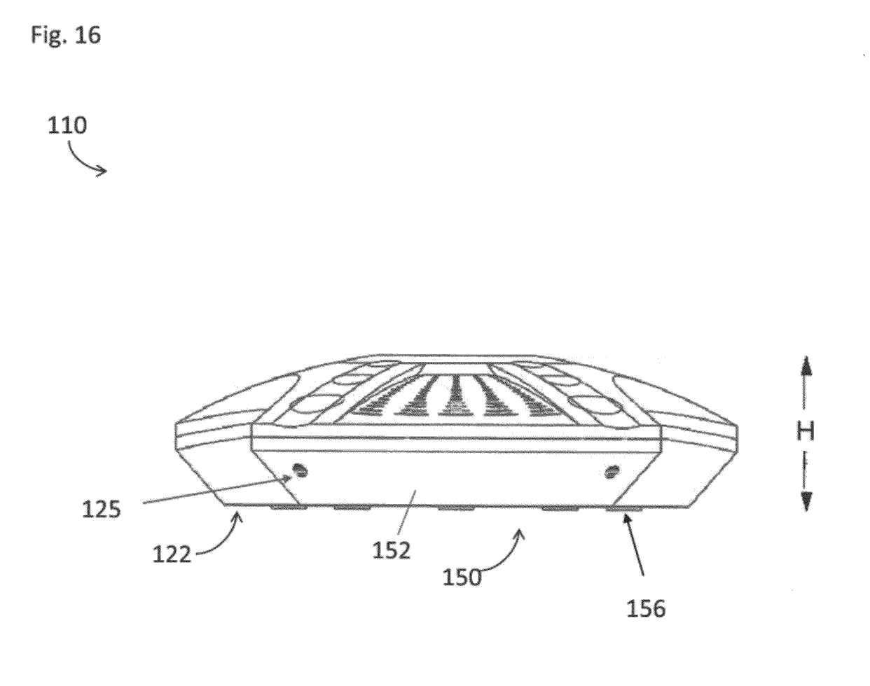

FIGS. 8-18 show an alternative embodiment of timed reaction game apparatus 100. Game apparatus 100 may include an electronic console 110, a plurality of illumination areas disposed on the electronic console, the plurality of illumination areas including an array of illumination areas 124. As discussed in further detail below, the array of illumination areas 124 may have one or both of a circular symmetry and a radial symmetry and may be configured to display a visual cue sequence.

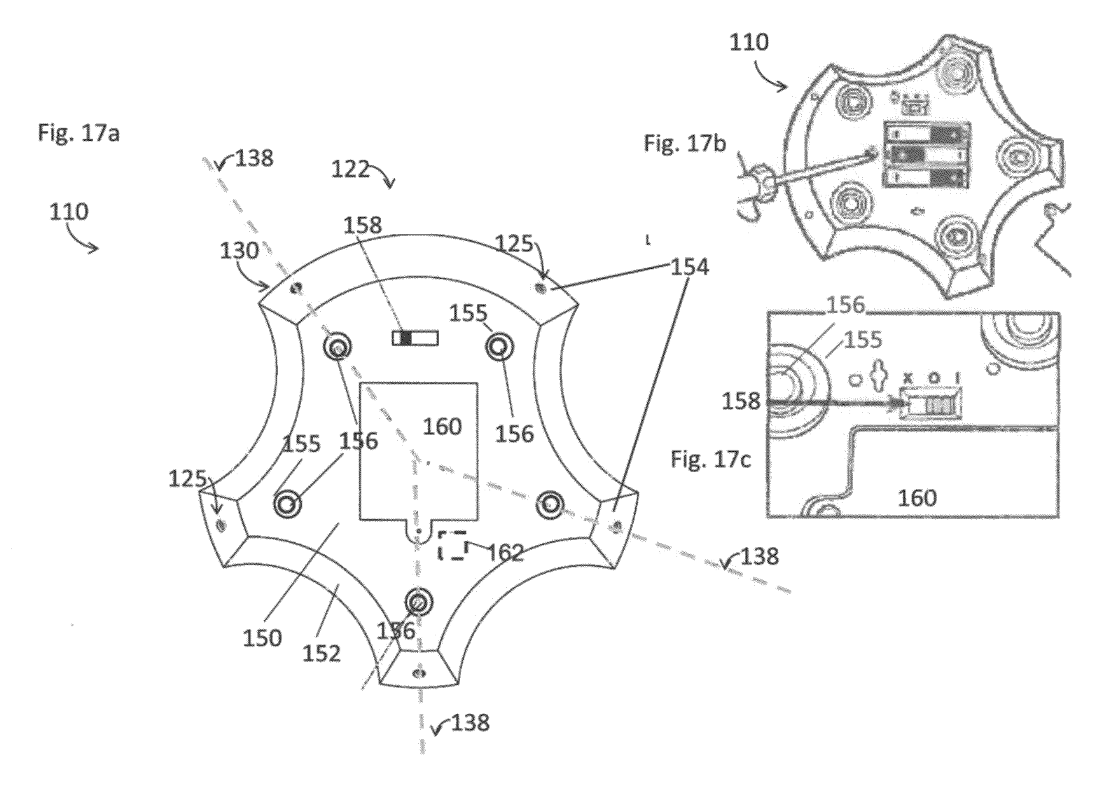

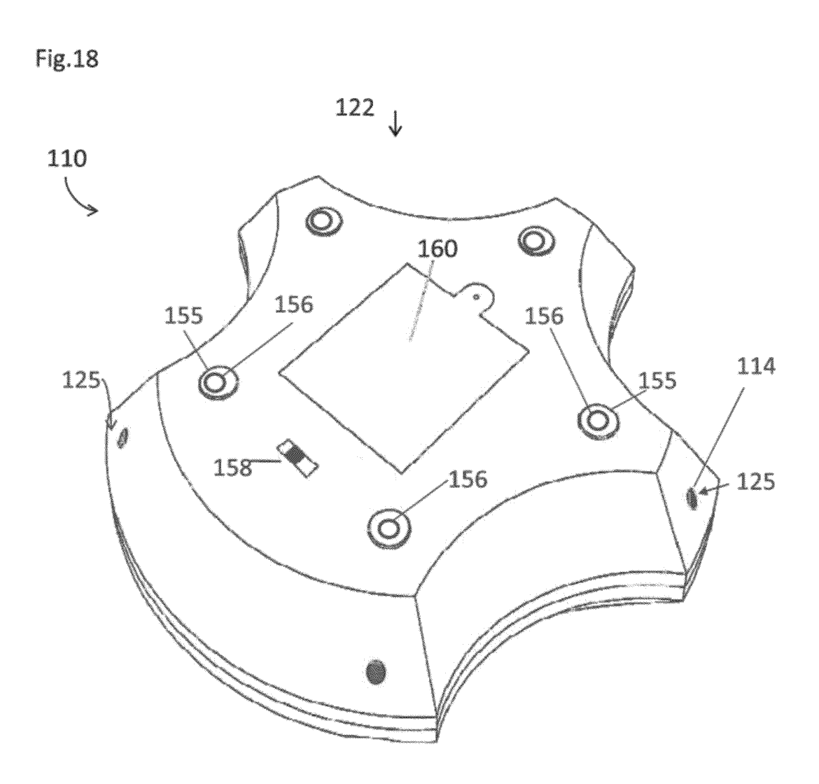

As discussed in further detail below with reference to FIGS. 17 and 18, game apparatus 100 may include an array of vibration sensors 156 attached to electronic console 110. Vibration sensors 156 may be in substantial radial alignment with illumination areas 124. Each of the vibration sensors may be associated with a target zone and may be configured to locate a tapping response proximate a respective vibration sensor. The target zone may include any area surrounding the vibration sensor from which the vibration sensor may detect a targeted vibration and/or each vibration sensor may be located at a midpoint of the target zone.

In some embodiments, electronic console 110 may include a plurality of arms 114 radially extending from electronic console 110. Arms 114 may be in substantial alignment with illumination areas 124. For example, five arms 114 may extend radially from console 110 in a radially symmetrical array. Each arm 114 may include one or more illumination areas and/or a shallow depression 115 extending a length of arm 114.

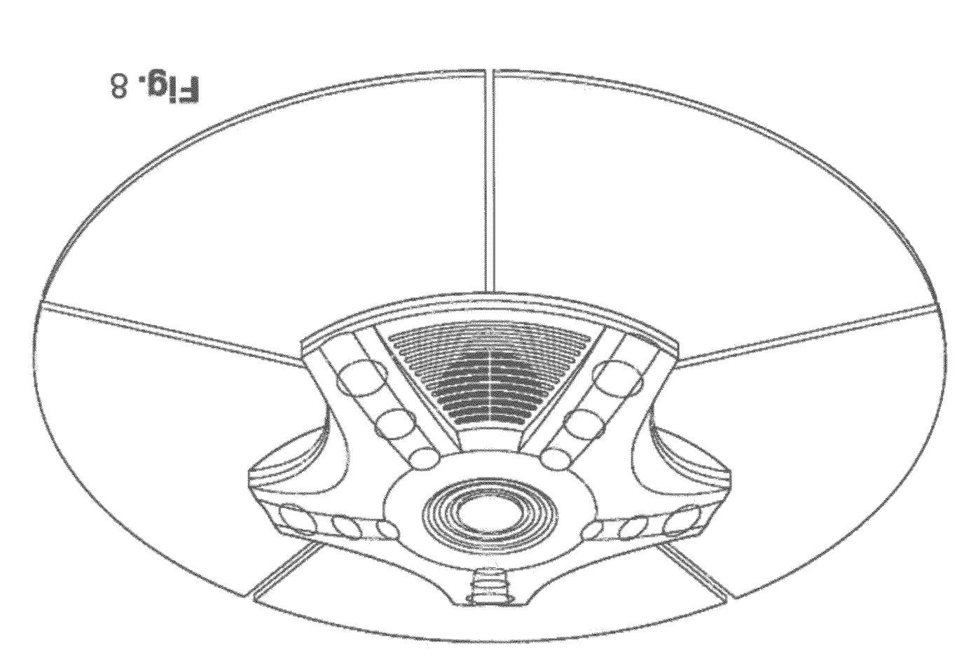

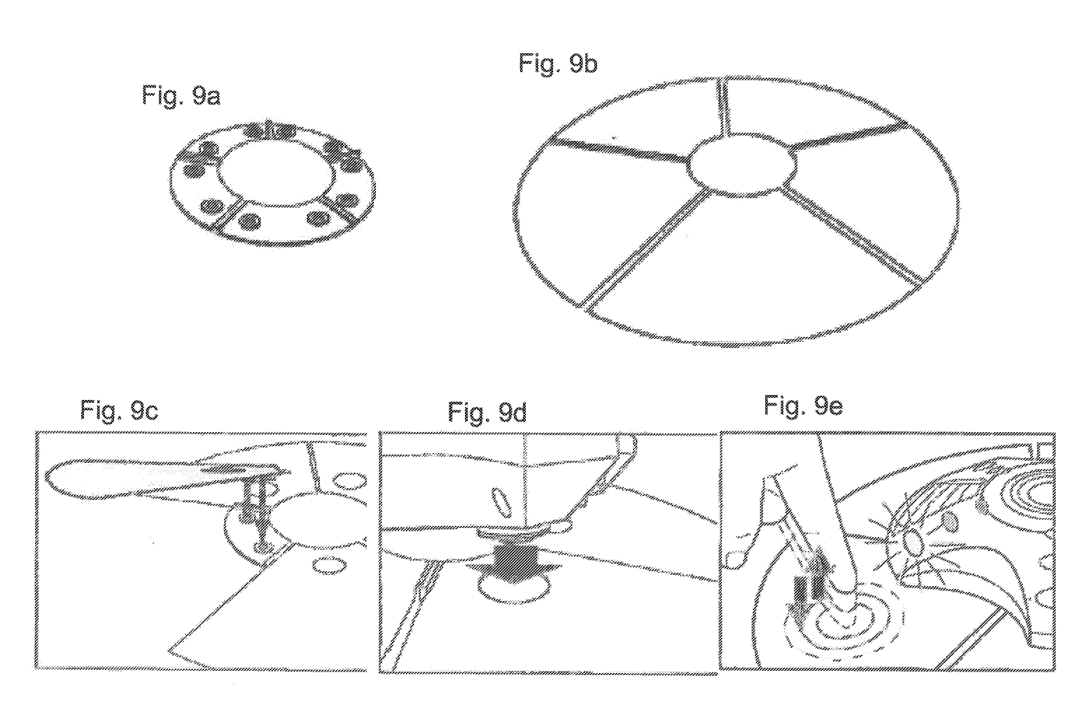

As shown in FIGS. 8 and 9a-e, game apparatus 100 may include a play surface 112 disposed underneath electronic console 110. Play surface 112 may be configured to provide a substantially isolated vibration translation environment in each target zone in a predefined area around each vibration sensor such that transmission of vibration into neighboring target zones is reduced. Alternatively and/or additionally, the play surface 112 may be configured to amplify or translate a vibration created within a target zone to a particular vibration sensor associated with the target zone.

For example, play surface 112 may include a play surface assembly 180, shown assembled in FIG. 8. Play surface assembly 180 may include a center hub 182 (FIG. 9a) and a plurality of segments 184 (FIG. 9b), which may be removably attachable to center hub 182 via removable attachment means 186 such that a portion of segment 184 lies on top of center hub 182. Some embodiments may include a segment for each vibration sensor 156, for each radial axis 138 and/or for each arm 114. FIG. 9c shows segment 184 being attached to center hub 182.

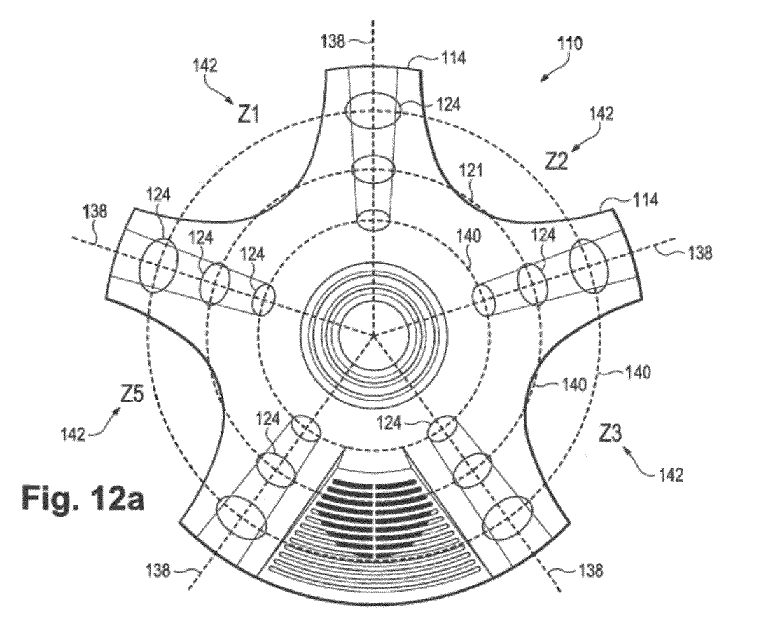

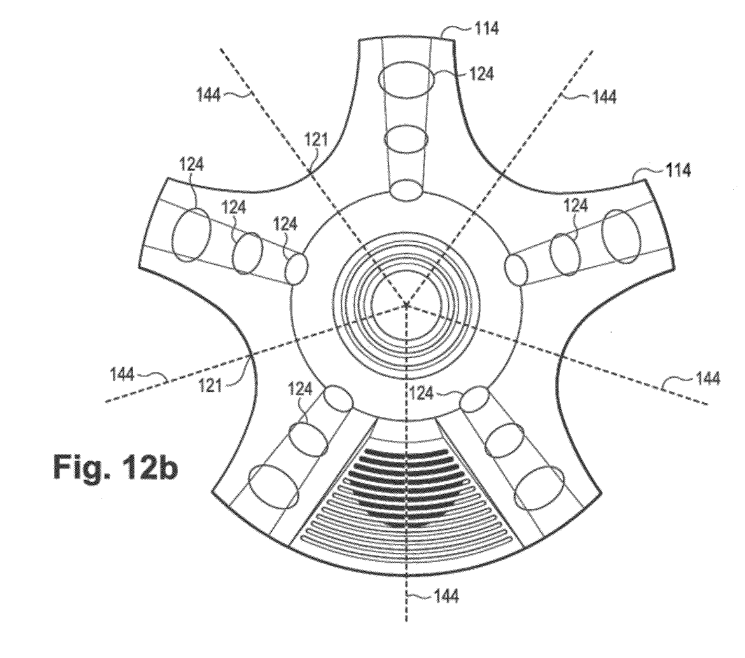

Each segment 184 may provide a predefined area 142 around vibration sensor 156 such that any vibration received in segment 184 is inhibited from being transmitted into neighboring segments 184. Predefined area 142 may also be referred to as a play zone. In some embodiments, predefined area 142 may include a substantially triangular shape radially extending from center hub 182. A border 144 of predefined area 142 around each vibration sensor 156 may be approximately located to intersect a midpoint 121 between two vibration sensors 156 (FIG. 17a). Additionally and/or alternatively, border 144 may be approximately located to intersect a midpoint 121 between two arms 114 (FIG. 12b). Additionally and/or alternatively, border 144 may be approximately located to intersect a midpoint 121 between two adjacent radial axes 138 of array of illumination areas 124 (FIG. 12a).

Each segment 184 may include a circular depression 190 configured to receive vibration sensor 156. FIG. 9d shows electronic console 110 being placed on play surface 112 and vibration sensor 156 being placed in depression 190. When assembled, segments 184 may be separated by a gap 188 or other means of reducing transmission of vibration to neighboring segments. Gap 188 may be approximately located to intersect a midpoint 121 between two vibration sensors.

Turning now to FIGS. 8 and 10-13, electronic console 110 may include a domed upper portion 120 having an upper surface 128. Console 110 may also include user input devices, such as buttons or switches, which may allow a player to control aspects and/or features of game play, and/or interact with game mode and feature menus. For example, upper portion 120 may include a central control button 148. Central control button 148 may include a diameter of Ø1.0005. Central control button 148 may lie in a central circle 149 including a diameter of Ø3.1986. Central circle 149 may intersect the inner most illumination areas 124.

Electronic console 110 may further include an audio output device such as a speaker 126 having a grill 132. Speaker 126 may be disposed between two illumination area radial axes 138 and may be configured to emit an auditory cue sequence in conjunction with the visual cue sequence. Electronic console 110 may include a length L of approximately 7.5028 inches.

As noted earlier, a plurality of illumination areas may be disposed on the electronic console 110. The plurality of illumination areas may include an array of illumination areas 124 configured to display a visual cue sequence. Each illumination area 124 may include a lighted ring 134 and/or a translucent pane 136.

Illumination areas 124 may be in approximate alignment with plurality of arms 114. For example, arms 114 may include illumination areas 124 on upper portion 120 of console 110, which may be disposed in a radial alignment relative to a central area 148. Illumination areas 124 may be substantially disposed in shallow depression 115 extending along arm 114. Arms 114 and/or array of illumination areas 124 may define radial axes 138, which may be radially symmetrical. For example, each radial axis 138 may be approximately Ø R from a nearest adjacent axis, wherein Ø R may be 72-degrees. Arms 114 and/or radial axes 138 may alternatively be described as spokes. Each arm 114 may be associated with a target zone and/or may visually accentuate the target zones for tapping.

Additionally and/or alternatively, array of illumination areas 124 may include circular arrangements 140 having circular symmetry. In other words, array of illumination areas 124 may include concentric circles in a symmetrical pattern. Alternative embodiments may include an array of illumination areas having a differently shaped concentric symmetry, for example hexagonal concentric symmetry.

Additionally and/or alternatively, array of illumination areas 124 may have one or both of circular and radial symmetries and may be configured to display a visual cue sequence. Illumination areas 124 may define nodes where radial axes 138 intersect circular arrangements 140. In some embodiments and/or some game play modes, illumination areas 124 may be illuminated according to a visual cue sequence that may progress along one or more of the radial axes 138, such as from an innermost illumination area to an outermost illumination area along a radial axis 138. Additionally and/or alternatively, illumination areas 124 may be illuminated in a visual cue sequence that progresses along a circular arrangement 140, such as in a clockwise direction or a counter-clockwise direction.

Illumination of illumination areas 124 in a visual cue sequence may include a spatial (directional, or orientation) component that is encoded by a direction of progression along at least a first axis (which may be one or more of a radial axis 138, or one or more of a circular arrangement 140). The visual cue sequence may further include a temporal component encoded by the time interval between illumination of illumination areas along a first axis and illumination of illumination areas along a second axis.

For example, a visual cue sequence may appear to radiate along a single spoke, from the center of the domed console to an outer edge, by progressive lighting of illumination areas 124 along one of radial axes 138, such as beginning with an area 124 on an inner circular arrangements 140 and proceeding to areas 124 on the next outer circular arrangement 140 and repeating successively at regular time intervals until a final area 124 on the peripheral circular arrangement 140 is illuminated. In such example, spatial information is encoded by progress along the illuminated radial axis 138, and temporal information is encoded by progress of the illumination series from inner circular arrangement 140 to outer circular arrangement.

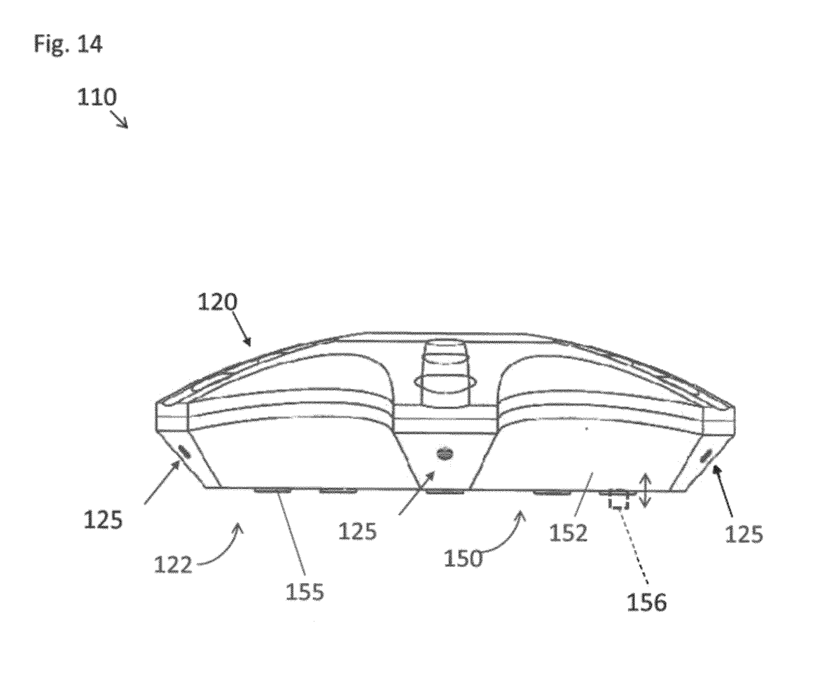

As shown in FIGS. 14-16, console 110 may include domed upper portion 120 mounted to a lower base portion 122 having a generally flat bottom 150 for stable positioning of game device 110 on a flat solid play surface, such as a table. Base portion 122 may also include an inclined portion 152. Some embodiments may include lower illumination surface areas 125. Console 110 may include a height H of 2.0623 inches.

FIGS. 17 and 18 show a non-exclusive exemplary configuration of lower base portion 122 of game device console 110, including plurality of vibration sensors 156. Each of the vibration sensors 156 may be disposed in a mounting foot 155. Mounting foot 155 may include a circular shaped cavity in which vibration sensor 156 is moveably disposed. As shown in FIGS. 14-16, mounting foot 155 may extend from the generally flat surface of base portion 122. Vibration sensor 156 may be disposed in mounting foot 155 such that vibration sensor 156 is perpendicularly moveable with respect to the ground and/or play surface 112. The moveable vibration sensor 156 will, therefore, contact the ground and/or play surface 112, even if that surface is not perfectly level. When electronic console 110 is held suspended over the ground and/or play surface 112, vibration sensor 156 may extend from mounting foot 155 by several millimeters, as represented in dashed lines in FIG. 14.

In some embodiments, vibration sensors 156 may include piezoelectric microphones capable of converting an externally applied vibration into an electrical input signal for storage and/or processing by an electronic processing unit or processor 162 housed within console 110. Processing unit 162 may compare the time at which a particular vibration is sensed at each of vibration sensors 156, and chooses the zone in which vibration sensor 156 first sensed the particular vibration.

In some embodiments, the vibration sensors may be configured to distinguish among a range of surface vibration intensities by generating electrical signals of different characteristics (such as frequency and/or amplitude) that correlate with surface vibration intensity, such performance capacity permitting a vibration generated at one proximate site adjacent console 110, such as in one predefined area 142, to be at least directionally distinguished and thereby functionally linked to the proximate (closest) vibration sensor among the plurality of such sensors disposed on lower base 122.

As shown in FIGS. 17 and 18, lower base 122 may further include a general power on/off switch 158, and an access panel 160 to a battery compartment.

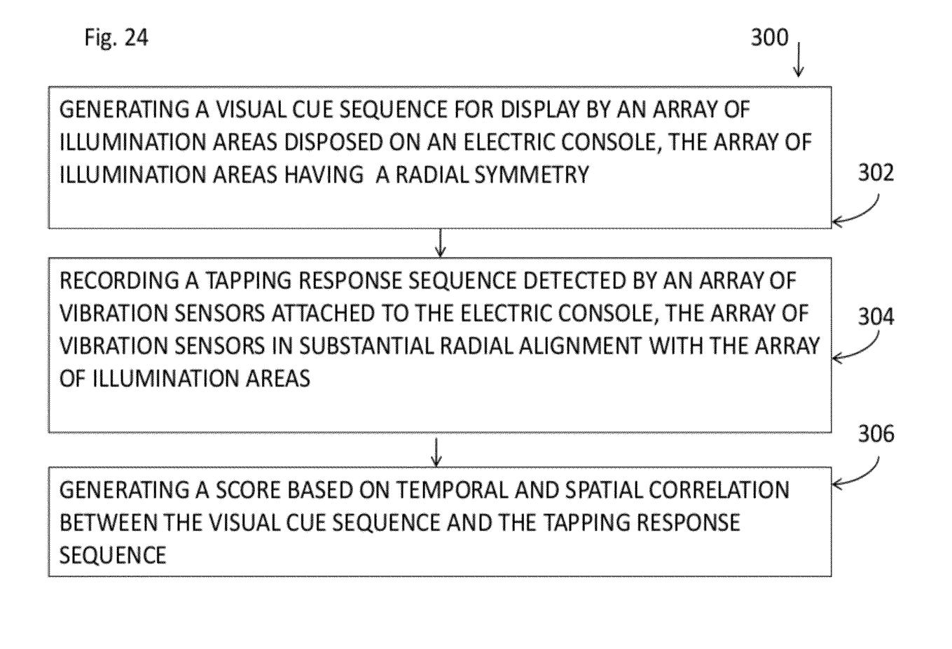

Processor 162 may be further configured to generate a visual cue sequence, to record a tapping response sequence detected by the vibration sensors, and to generate a score based on temporal correlation and spatial correlation between a visual cue sequence and a tapping response sequence. FIG. 24 shows a flow diagram of an exemplary method of a timed reaction game processing 300 including generating a visual cue sequence for display by an array of illumination areas disposed on an electronic console, the array of illumination areas having a radial symmetry 302 and recording a tapping response sequence detected by an array of vibration sensors attached to the electronic console, the array of vibration sensors in substantial radial alignment with the array of illumination areas 304. The method may further include generating a score based on temporal and spatial correlation between the visual cue sequence and the tapping response sequence 306.

FIGS. 19-23 show non-exclusive examples of game play modes for a timed response game device including console of the present disclosure. FIG. 19 shows an example game mode wherein an object of the game is to stay on beat. Console generates a beat of consistent interval, which may include an audible cue sequence from a speaker correlated with a visual cue sequence from illumination areas. Player listens to the beat and watches the lights travel from, for example, the center of the unit to the outside (peripheral) light ring (circular arrangement). Player then taps the appropriate play surface predefined area “on” the beat as the out lights turn on. Beats and lights may be generated for two play surface predefined areas (along two radial axes) at once. The beats may speed up (have decreased time intervals) as play continues. The game console may give a total score of zones properly hit “on the beat” when the game is completed.

Additionally and/or alternatively, and “on the beat” game mode may be described as follows: Number of Players: 1-4; Object: Build a song by tapping the play mat as lights reach the bottom. On your turn, a song will begin playing and lights will descend the 5 different light zones. When a light reaches the bottom of a zone, tap the corresponding section of the play mat. As the game goes on, the number and speed of the lights will increase. Depending on how many correct hits you score, the device will add more layers to the song. The better you do, the better the song will sound! When time is up, the device will announce the number of hits you scored then call on the next player to go (if more than 1 player was selected). Once everyone has had a turn, the device will announce the winner. Winning the Game: Score the most points or try to beat your best score!

FIG. 20 shows an example game mode wherein an object of the game is to defuse a simulated bomb before it explodes, which a player may achieve by tapping in a pre-determined five-zone sequence that must be discovered by a player's tapping. An object may be to defuse as many bombs as possible in a time period, such as 60 seconds. A game may start with the unit initiating a detonation period, or “tick-down” clock, for example from 20 to zero. For example, a player may tap in several of predetermined areas to find a first correct zone. Tapping on an incorrect zone or zones may result in console producing a negative sound effect, such as a buzz or siren. Once a correct zone is identified by the player, the lights for that zone (along the aligned radial axis) will light up and/or stay on. A player then finds the second correct zone by tapping the first correct zone again and then adding the next correct zone.

A game continues until a player can successfully tap all five zones in the correct sequence before the time period ends (before time runs out). A failure to tap in the correct sequence in the prescribed time period results in the console producing an exploding bomb sound effect and light show, which may signify a bomb blast. Bomb blast game mode may include a two-player option, wherein a player attempts to dismantle the bomb faster than an opponent.

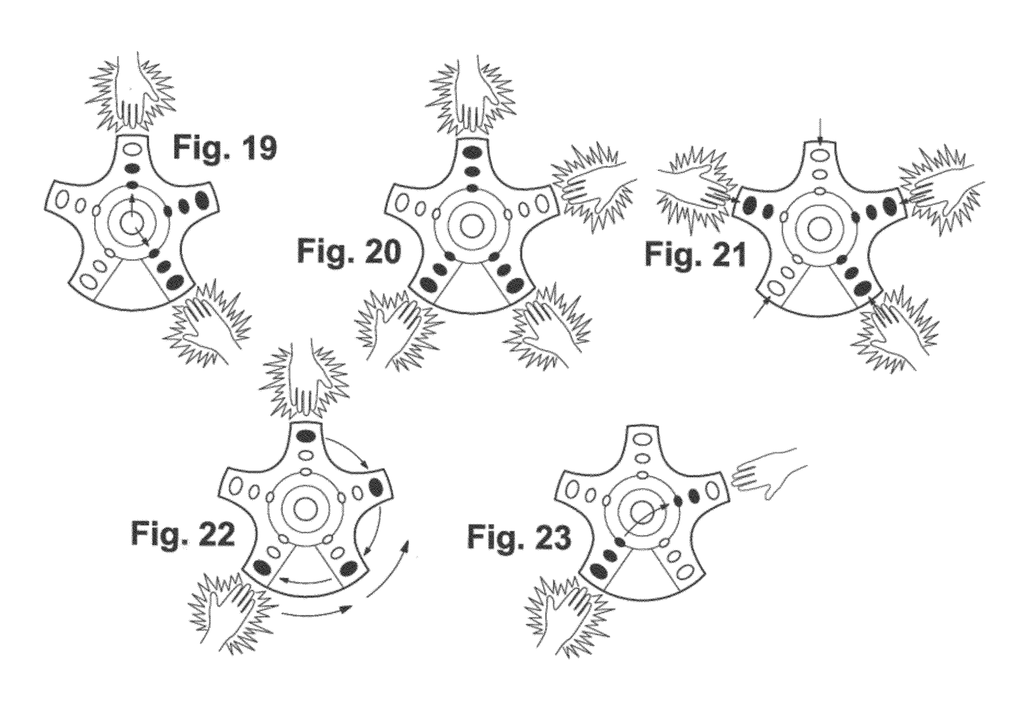

FIG. 21 shows an example game mode, wherein an object of the game is to get all the lights to rise to the center of the console upper portion, which a player may promote by tapping each play surface zone. Light sequences may rise more quickly along some radial axes (requiring few or no taps within their associated play surface zones) than sequence along other axes which rise more slowly (requiring more taps in their associated play surface zones). A player who gets all the light sequences (balloons) to reach the top (the center of the upper portion) before the time runs out may be the winner or provided an increased score or other advancement.

FIG. 22 shows an example game mode 96 wherein a player, or multiple players, is/are assigned a play surface zone (associated with a radial axis) and the console 10 presents a visual sequence that progresses around a circular arrangements, for example in a clockwise direction, and wherein an object of the game is for each player to tap the table on the beat as the rotating light passes into their associated and assigned play surface zone. Tapping in the appropriate zone, on the beat (i.e., in synchrony with the presented sequence) reverses the direction of the light sequence. With two players, the direction of the light sequence is reverse back to the opposing player. In the event the sequence passes a first player without a proper tap response, and hence returns to the second (opponent) player in the same direction, tapping within that player's zone properly synchronized “on the beat” causes the lights to rotate around the circular arrangement more quickly, which may increase the difficulty for the first player to properly tap within his zone when the light sequence again reaches his/her side (radial axis), which evokes a phenomenon of actual tetherball. Each time a player causes their opponent to miss the light, an additional one of the illumination areas in their own zone (along their radial axis) is illuminated, thus marking progress (similar to winding the tether around the post in tetherball). A player succeeds in getting all lights, for example four lights, in their radial axis to light up, and this player is declared the winner. In an alternative version of the game, all of the lights on the console 10 begin lit up, and the visual sequence that progresses around the console is a pattern of darkness, i.e. one or more lights being turned off in a particular pattern. Thus, the players may simulate tapping a tetherball of one or more darkened lights around the console.

FIG. 23 shows an example game mode (similar to ping pong), wherein an object of the game is to bounce the light back to your opponent. Two opposing players are assigned opposite pairs of play surface zones, such that two radial axes pass directly across the console between them. Thus, a first player controls tow light zones and a second player controls the opposite two zones. By tapping on the table, the first player lights up the areas on the radial axes generating visual sequences along the radial axes heading in the direction of (heading towards) the second player. The second player is required to tap the table when the light reaches the nearest of the illumination area (i.e., the bottom of the series on the domed console axes), to reverse the light sequence direction and send it back to the first player. The light can “bounce” to either of the two zones on an opponent's side, or come right back to you to tap again. When a player taps the play surface zone too soon, or too late, the opposing player scores a point. A game may continue to a predetermined number of points, such as 10 points.

Additionally and/or alternatively, volley game mode may be described as follows: Number of Players: 1-2; Object: “Bounce” a light back and forth as many times as you can before making 3 mistakes! Alight will descend one of the 5 zones. Tap the corresponding section of the play mat when the light reaches the bottom light ring to bounce the light back up. The light will continue to descend different light zones at random—but be ready! Sometimes the light will try to fake you out by starting down one zone then suddenly changing direction! Tap the play mat too soon or too late and it counts as a mistake. Winning the Game: After you make 3 mistakes, the device will announce the number of hits you scored. Try to beat your best score!

Two Players

The device will announce “Player One!” and light up the 2 zones Player One is responsible for. It will then call out “Player Two!” and light up the zones Player Two is responsible for. A light will descend one of the zones. When it reaches the bottom light ring, the player responsible for that zone taps the corresponding section of the play mat to bounce the light back up. The light may bounce to one of your opponent's zones, but it could also bounce right back to you, or it could even try to fake you out. Tap the play mat too soon or too late and it counts as a mistake. Winning the Game: When one player makes 3 mistakes, the other player wins!

A further game mode may include a “Versus” challenge between opposing players. A first player may being by creating a first two-zone beat “sample”, by tapping twice (using one or more zones, and creating a single time interval between taps). A next player must copy the first beat sample, and then add an additional beat by tapping in an additional zone (the same or another). Players rotate turns, copying and adding until one player makes an error in zone and/or time interval. The winner is identified by the console game device.

A further game mode may include a “free style DJ” mode to create music by mixing five different tracks. The device will ask you to select one of 3 “levels” each one consisting of 5 unique sound effects. Tap the play mat to cycle through the levels—identified by different drumbeats—then press the menu button to select the one you want. The drumbeat for the chosen level will continue to play in the background. Start tapping around the play mat. Each of the console's 5 zones is linked to a different sound effect, so each time you tap you will trigger the sound for that zone. If you want to select a different set of sounds, just press the menu button to return to the Game Menu, choose “Freestyle DJ” and pick a different level.

A further game mode may be described as light lifter for 1-4 players having an object of turning off as many lights as you can before they reach the bottom and go out. On your turn, lights will descend multiple zones at the same time. Tap the play mat at the end of each zone before the light reaches the bottom to turn that light off. Tapping a zone that is not lit up counts as a mistake. If you make 3 mistakes, or if a light reaches the bottom ring and goes out before you turn it off, your game ends. The device will announce the player's score then call on the next player (if more than 1 player was selected). Once everyone has had a turn, the device will announce the winner. Winning the Game: Score the most points or try to beat your best score!

A further game mode may be described as memory beats for 1 player having an object of repeating an ever-increasing pattern of lights. A light zone will flash. Repeat it by tapping the corresponding section of the play mat. If you are correct, the device will replay it and add one more light zone to the sequence. Continue repeating the ever-growing pattern of lights as long as you can. If you make 3 mistakes, the game ends. Winning the Game: Score 15 hits to win the game

Additionally and/or alternatively, a timed reaction game in accordance with the present disclosure may be described as follows: a timed reaction game including a central console which presents visual cue sequences combining temporal and spatial components and which receives player input via vibration sensors in contact with a zonal play surface, wherein the visual cues may be varied through direction from the console and/or input from opposed players, and a player's tapping responses within the zonal play surface are scored for temporal and spatial correlation to the ongoing visual cue series. In some examples, the central console may display visual cues through a lighted area array that includes an orthogonal series of radial axes and circular alignments. In some examples, the console may receive vibration input through a circular array of piezoelectric sensors that determine which sensor is nearest a player's tapping input within the zonal play surface. In some examples, visual cue series may include associated audible cues. In some examples, the game console may be used in conjunction with a tiled play board and/or with hand-held percussive devices for tapping the play surface. A variety of methods of game play are provided.

Additionally and/or alternatively, a timed reaction game device in accordance with the present disclosure may be described as follows: An electronic game device is provided for presenting a player with a variable series of visual and audible cues, and for monitoring the timing and proximate location of a player's percussive response on an adjacent play surface, such as a tap made on the play surface in particular relation to the time and direction of presented cues.

Some embodiments include a game device electronic console having a generally domed structure, including an upper domed portion mounted to a lower base portion configured to rest on a flat solid play surface. In some embodiments, the electronic console may have a generally discoid shape. In other alternative embodiments, the electronic console may have a spoked, or star-like, surface topology in which the generally domed structure includes several arms that radiate from a common central portion. In such embodiments, illuminated areas, such as rings or circles, may be disposed as a visual cue array on the surface of the upper domed portion and configured to allow visual cues to be presented to a player with variable spatial and temporal features. In such embodiments, the electronic console further includes piezoelectric sensor devices mounted to the base portion and configured to detect vibrations of the playing surface generated by a player by tapping on the solid play surface in response to visual cues presented by the console. In some examples, the piezoelectric sensors may form a generally circular array mounted on the console base and configured to correspond to the spatial axes of the visual cue array disposed on the console dome and, simultaneously, functionally define a zonal organization of the subjacent play surface. The console may further include illumination devices disposed on the lower base portion and/or at a margin between the upper dome and lower base portions, which may illuminate adjacent portions of the play surface, which may thereby visually identify the zonal organization of the play surface in correspondence with spatial features of visual cues displayed by the upper domed portion of the console.

In some examples, the game device console may further include audible output devices, such as a speaker, configured to emit auditory cues independent or in conjunction with visual cues. In some examples, the game device console may be provided with one or more handheld percussive devices configured for tapping on the play surface adjacent the electronic console.

Variable methods of game play are provided suitable for use with such embodiments. One game play method may involve one or more players attempting to hit a time mark at the end of a series of time-gapped visual cues, such as by slapping or tapping the play surface adjacent the console (e.g., Console presents light 1, time-gap 10 units, light 2, time-gap 10 units, light 3; player must respond after time-gap 9-11 units with a tap on the adjacent play surface). Variations may occur in each successive trial, including directionality of the light cues (requiring a player tap the play surface proximate the final light cue), increasing the speed (decreasing the time-gap) of the visual cues (requiring a similar change in player response timing), and/or multiple overlapping visual cue series (such as to require player responses with more than one hand). A further game play method may require a player determination a correct sequence of tapping zones of the play surface prior to a series of visual cues being completed, such as a ticking time-bomb. A further game play method may include manipulating a speed of several series of visual cues (emulating floating balloons) by tapping the adjacent play surface, a goal of the game being to have all visual cue series reach a top (center) position at the same time. Further game play methods for competition between two players may include a tap-induced manipulation of rotational progression of the visual cue series in a circular pattern around the console upper dome, similar to tether ball, and tap-induced reflection of a visual cue series across the top of the console upper dome, similar to a pong game.

A particular embodiment includes an electronic toy that combines light, music, reflex, and memory. The unit consists of a dome shaped device that rests on a cardboard play surface on a table top. The device is able to detect vibration in five different zones. Each zone is activated by tapping in the one of the five zones with a tapping device, and, when activated, each zone causes the speaker to output a unique music sample. In other words, each zone contains a unique music sample. Light rings on top of the device create a lightshow that lead the game play and reward the user when they achieve victories. The present game will provide excitement and fun for all.

In exemplary embodiments of the present invention, the contents of a game set include a main game console, a play mat that includes six interlocking pieces, and an instruction manual.

Contents of an alternative game set might include the following elements.
Main Console
2 Tappers
Interlocking Cardboard Play Surface
Instruction Manual

The Main Console unit consists of a dome shaped device that rests on a table top. It contains 5 piezo speakers located on the bottom surface that rest on a cardboard play surface on a table top. The play surface is broken into 5 interlocking puzzle pieces. The piezo speakers are able to detect vibration around the device. The area around the device is divided into 5 different zones. Each zone contains a unique music sample. Each zone is activated by tapping in the zone with a tapping device.

On top of the dome is a series of translucent light rings starting from the center, to the outside edges around the dome. There are also 5 LED's on the bottom of the unit which illuminate the five zones on the table. When a zone is activated by tapping, the single row of light rings on the top and bottom of the device that correspond to that zone will light up. A lightshow will accompany the tapping of the zones and music samples. The lightshow leads the game play in many of the modes.

The device is powered on by the switch on the bottom of the unit. On top of the unit is the Menu button. Surrounding the Menu button is a frosted translucent wave lens. This wave lens has 3 LED's underneath which will pulsate to the beat of the music. The speaker is on top the unit between two of the zones.

Menu Navigation

In some embodiments of the present invention, pressing a menu button once activates a game console. An audio cue from the activated game console may prompt the player to select a game. The player may then impart vibrations on a play mat by “tapping” the mat with a finger or other device to cycle through various game play selections. The game console may provide additional audio cues indicating one or more game play selections after each tap of the mat. The player may choose a game play option by pressing the menu button after hearing a desired audio cue. The game console may allow audio volume levels to be changed only immediately after the game console is activated. The player may press and hold down the menu button to cycle through various volume settings, which may be indicated by various audio cues. The player may select a volume setting by releasing the menu button.

In other embodiments, audio prompts will lead users through the various menus. Areas of the menu include music style, volume, game mode selection, number of players, and difficulty level. When in the main menu, you can tap in different zones to navigate through the menus. Pressing the menu button on top of the unit will activate the main menu. Tapping in the zone clockwise from the original zone will advance forward through the menu and tapping in the zone counterclockwise from the original zone will move backward through the menu. The light rings designated for each zone will light up when tapped during menu navigation. Volume can be increased or decreased by navigating to the volume menu and tapping either clockwise to lower the volume or counterclockwise to increase the volume.

GAME PLAY typically includes 6 games and 1 freestyle mode.
Tap between different zones moving from one sample to the next. (Add one)
First player starts by creating a 2 zone beat sample by tapping the zones.
Next player must copy the first players' beat sample and add an additional zone.
Players rotate turns, copying the last players beat sample and adding one more until somebody misses.
The electronic game identifies the winner when game is over.

The individual Light Rings on top of the unit preferably light up bright enough for the user to see in a normal lit room, but with minimal bleeding of light from one light ring to the next. Lights on the bottom of the unit preferably illuminate the table top enough to be seen from any side of the unit. The light rings generally illuminate to the beat of the music.

The exemplary embodiments and methods illustrated and disclosed herein are believed to encompass multiple distinct inventions with independent utility. While each has been disclosed in an exemplary form, the specific embodiments thereof as disclosed and illustrated herein are not to be considered in a limiting sense, as numerous variations of the concepts and components are possible. The subject matter of the inventions includes all novel and non-obvious combinations and sub-combinations of the various elements, features, functions and/or properties disclosed herein.

Where any description recites “a” or “a first” element or the equivalent thereof, such description should be understood to include incorporation of one or more such elements, neither requiring nor excluding two or more such elements.

What is claimed is:

1. A timed reaction game apparatus comprising:
an electronic console;
a plurality of illumination areas disposed on the electronic console, the plurality of illumination areas including an array having a radial symmetry and configured to display a visual cue sequence;
an array of vibration sensors attached to the electronic console in substantial radial alignment with the illumination areas, wherein each of the vibration sensors is associated with a target zone and is configured to locate a tapping response proximate to a respective vibration sensor; and
a processor configured to generate the visual cue sequence, to record a tapping response sequence detected by the vibration sensors, and to generate a score based on temporal correlation and spatial correlation between a visual cue sequence and a tapping response sequence.

2. The timed reaction game apparatus of claim 1, wherein each vibration sensor is located at a midpoint of the target zone.

3. The timed reaction game apparatus of claim 2, further comprising a play surface disposed underneath the electronic console, the play surface configured to provide a substantially isolated vibration translation environment in a predefined area around each vibration sensor such that transmission of vibration into neighboring target zones is reduced.

4. The timed reaction game apparatus of claim 2, wherein the electronic console includes a plurality of arms radially extending from the electronic console in substantial alignment with the illumination areas.

5. The timed reaction game apparatus of claim 1, further comprising an audio output device disposed between two of the illumination area radial axes, the audio output device configured to emit an auditory cue sequence in conjunction with the visual cue sequence.

6. The timed reaction game apparatus of claim 3, wherein a border of the predefined area around each vibration sensor is approximately located to intersect a midpoint between two vibration sensors.

7. The timed reaction game apparatus of claim 1, further comprising a control button disposed in the electronic console at a center of the illumination area radial axes.

8. A timed reaction game apparatus comprising:
an electronic console including a plurality of arms radially extending from the electronic console, each arm associated with a target zone;
a plurality of illumination areas disposed on the electronic console including an array of illumination areas in approximate alignment with the plurality of arms and configured to display a visual cue sequence;
an array of vibration sensors attached to the electronic console in approximate alignment with the plurality of arms, the vibration sensors configured to detect a tapping response sequence in the target zones; and
a processor configured to generate the visual cue sequence displayed by the illumination areas, to record a tapping response sequence detected by the vibration sensors, and to generate a score based on temporal and spatial correlation between the visual cue sequence and the tapping response sequence.

9. The timed reaction game apparatus of claim 8, further comprising a play surface in operable contact with the array of vibration sensors and configured to provide a substantially isolated vibration translation environment in a predefined area around each vibration sensor such that transmission of vibration into neighboring target zones is reduced.

10. The timed reaction game apparatus of claim 8, further comprising an audio output device configured to emit an auditory cue sequence in conjunction with the visual cue sequence.

11. The timed reaction game apparatus of claim 9, wherein a border of the predefined area around each vibration sensor is approximately located to intersect a midpoint between two vibration sensors.

12. The timed reaction game apparatus of claim 11, wherein the predefined area around each vibration sensor includes a triangular shape.

13. The timed reaction game apparatus of claim 8, wherein the array of illumination areas and the array of vibration sensors are in substantial radial alignment with the plurality of arms.

14. A timed reaction game apparatus comprising:
an electronic console;
a plurality of illumination areas disposed on the electronic console, the plurality of illumination areas including an array of illumination areas configured to display a visual cue sequence;
an array of vibration sensors attached to the electronic console in approximate alignment with the array of illumination areas, each vibration sensor associated with a target zone and configured to locate a tapping response in the target zone; and
a play surface in operable contact with the array of vibration sensors and configured to provide a substantially isolated vibration translation environment in a predefined area around each vibration sensor such that transmission of vibration into neighboring target zones is reduced.

15. The timed reaction game apparatus of claim 14, wherein the plurality of illumination areas includes an array having a radial symmetry.

16. The timed reaction game apparatus of claim 15, further comprising a processor configured to generate the visual cue sequence displayed by the illumination areas, to record a tapping response sequence generated by activation of the vibration sensors, and to generate a score based on temporal and spatial correlation between the visual cue sequence and the tapping response sequence.

17. The timed reaction game apparatus of claim 14, further comprising an audio output device disposed between two of the illumination area radial axes, the audio output device configured to emit an auditory cue sequence in conjunction with the visual cue sequence.

18. The timed reaction game apparatus of claim 14, wherein the predefined area around each vibration sensor includes a triangular shape.

19. The timed reaction game apparatus of claim 14, further comprising a plurality of arms radially extending from the electronic console in radial alignment with the illumination areas.

20. A method of a timed reaction game processing comprising:
generating a visual cue sequence for display by an array of illumination areas disposed on an electronic console, the array of illumination areas having a radial symmetry;
recording a tapping response sequence detected by an array of vibration sensors attached to the electronic console, the array of vibration sensors in substantial radial alignment with the array of illumination areas; and
generating a score based on temporal and spatial correlation between the visual cue sequence and the tapping response sequence.
